(19) United States
(12) Patent Application Publication
(10) Pub. No.: US 2008/0085741 A1
(43) Pub. Date: Apr. 10, 2008

(54) METHOD FOR PROVIDING AN ALERT SIGNAL

(75) Inventors: Klas Goran Tauberman, Lund (SE); Michael Henriksson, Loddekopinge (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 11/539,876

(22) Filed: Oct. 10, 2006

(51) Int. Cl. H04B 1/38; H04M 1/00

(52) U.S. Cl. 455/567

(57) ABSTRACT

A method for providing an alert signal in an electronic device, such as a mobile phone, comprises the steps of: presenting graphics on a display of the device, including information or images; detecting an event in the device, such as an incoming call or a status change of a parameter value in the device; and distorting the graphics on the display to alert a user of the device. The distortion may be provided as a filter applied to the graphics to be displayed, such that a wave pattern or segmentation of the graphics is obtained. Different distortion profiles may be used for different events, and may also be correlated to audible alert signals, in terms of frequency content and synchronicity.

### FIELD OF THE INVENTION

The present invention relates to methods for providing alert signals in electronic devices, i.e. to output some form of signal for the purpose of informing a user of the electronic device that an event has occurred in or been detected by the device. In this context, the electronic device may take any form in which such alert signals are useful, such as in hi-fi equipment, digital cameras, computers, and so on. However, the invention will be described herein in the context of communication terminals, such as mobile phones. The invention makes use of a graphical user interface, on which presented graphics are distorted to alert the user when an event has occurred, such as an incoming call.

### BACKGROUND OF THE INVENTION

Electronic devices such as mobile phones and computers including wireless communication transceivers typically include both a user input interface in the form of keys or buttons, and a user output interface in the form of one or more displays. Audio interfaces are normally also included by means of speakers and microphones. In electronic devices in which events may occur without direct user interaction, it is often necessary to provide some form of alert signal to gain a user's attention. The most common example is perhaps the traditional alert used in telephony. When a call is received in a telephone, the telephone is triggered to sound an audible alert signal. While the original alert signal was providing by a ringing bell, modern day telephony, and in particular in mobile telephony, allows for almost any kind of sound signal to be generated. Still, the object is the same, i.e. to provide an audible alert signal. Another option is to use vibrations, a silent form of alert signals frequently used in mobile telephony, which does not require that the user watches the telephone.

Many electronic devices of today include a display for presenting information to a user. For this reason, alert signals may additionally, or optionally, be provided as visual signals. One way is to simply provide a text spelling out the event in question, such as “Susan is calling”, “You have received a message”, “Battery low”, “Memory full”, and so on. As an alternative, an image may be presented, indicating the event in question. Corresponding to the alert signals above, such images may be a picture of Susan with a telephone beside it, a picture of a letter indicating a received message, a blinking empty battery symbol, a blinking diskette icon, and so on.

When visual alert signals are used, the content or information currently presented on the display will typically be partly or fully obscured. This may in some instances be annoying for the user, if the user e.g. is reading a text or playing a game on the display.

### SUMMARY OF THE INVENTION

It is a general object of the invention to provide a solution for alerting a user of an electronic device that an event has taken place in or been detected by the electronic device.

According to a first aspect, this object is fulfilled by means of a method for providing an alert signal in an electronic device, comprising the steps of:
presenting graphics on a display of the device;
detecting an event in the device;
distorting the graphics on the display to alert a user of the device.

In one embodiment, the method comprises the steps of:
determining type of the event;
distorting the graphics in accordance with a stored profile associated with the determined type of event.

In one embodiment, the method comprises the steps of:
analyzing a sound signal associated with the event;
distorting the graphics dependent on the sound signal.

In one embodiment, the method comprises the steps of:
analyzing audio frequency content of the sound signal associated with the event;
distorting the graphics dependent on the frequency content.

In one embodiment, the step of distorting the graphics comprises the step of:
providing an oscillation in the graphics having a spatial frequency correlating with the audio frequency of the sound signal.

In one embodiment, the method comprises the steps of:
analyzing audio frequency content of the sound signal associated with the event, to determine presence of tones in a low frequency range and in a high frequency range;
distorting the graphics with a low spatial frequency for tones in the low frequency range, and with a high spatial frequency for tones in the high frequency range.

In one embodiment, the step of distorting the graphics comprises the step of:
providing an oscillation or segmentation of the presented graphics as a distortion filter applied over the presented graphics.

In one embodiment, the event is reception of an incoming telephone call or message.

In one embodiment, the event is computer game event of a game played on the electronic device.

In one embodiment, the event is a status change of a parameter in the electronic device.

In one embodiment, the event is an alarm.

In one embodiment, the electronic device is a mobile phone.

### BRIEF DESCRIPTION OF THE DRAWINGS

The features and advantages of the present invention will be apparent from the following detailed description of the invention and preferred embodiments, with reference to the accompanying drawings, on which

FIG. 1 schematically illustrates an electronic device in the form of a mobile phone, configured to be operated in accordance with an embodiment of the invention;

FIG. 2 schematically illustrates functional blocks of the electronic device of FIG. 1;

FIG. 3 schematically illustrates a desk top graphics for presentation on a display of a mobile phone, including selectable icons;

FIG. 4 schematically illustrates the desktop graphics of FIG. 3, when subjected to a low frequency distortion;

FIG. 5 schematically illustrates the desktop graphics of FIG. 3, when subjected to a high frequency distortion.

### DETAILED DESCRIPTION OF PREFERRED EMBODIMENTS

The present description relates to the field of electronic devices configured to issue an alert signal responsive to the occurrence of an event in or detected by the electronic device. As already mentioned, there are many different types of electronic devices in which the present invention may be employed, which are all devised with a display. Henceforth, the invention will be described in the context of mobile communications, i.e. where the electronic device is a radio communication terminal such as a mobile phone. Furthermore, it should be emphasized that the term comprising or comprises, when used in this description and in the appended claims to indicate included features, elements or steps, is in no way to be interpreted as excluding the presence of other features elements or steps than those expressly stated.

Examples of embodiments will now be described with references made to the accompanying drawing.

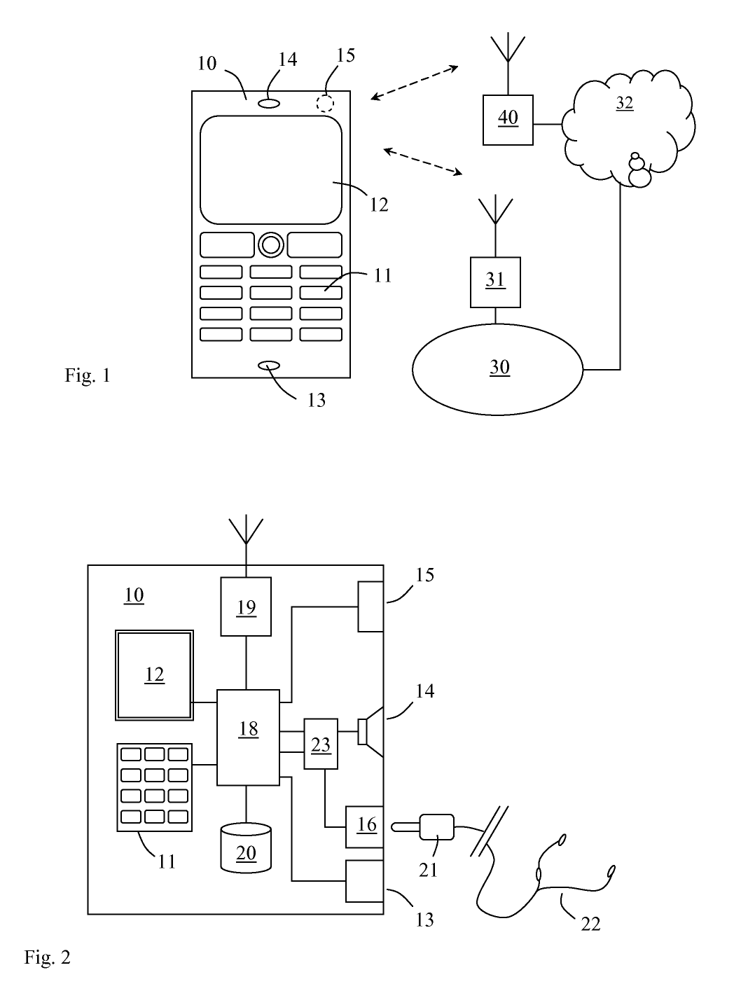

FIG. 1 illustrates the outer appearance of an electronic device in the form of a typical mobile phone, which may be configured to employ an embodiment of the present invention, whereas FIG. 2 schematically illustrates functional features of the mobile phone by means of a block diagram. It should be noted that the elements indicated in FIG. 2 need not necessarily be physically divided in the manner shown, and that it is the functional relationship rather than the structural arrangement that is of primary interest. Furthermore, the outer appearance of the mobile phone need not take the indicated shape of FIG. 1, instead the mobile phone may e.g. be of a clamshell type, a jack knife type, or the like.

Mobile phone 10 is configured to operate in a cellular radio communications network 30, by radio communication with a base station 31, or by direct radio communication with another mobile phone as a walkie-talkie. The radio communications network 30 may e.g. be a GSM network or a WCDMA 3G network. In addition, mobile phone 10 may be provided with a radio signal transceiver configured to operate in a IEEE 802.11 WLAN over an access point 40 connected to the Internet 32.

The mobile phone 10 includes a user interface comprising an input part, preferably including a set of keys 11, and additionally or optionally a touch-sensitive display. An output part of the user interface includes a display 12 for presenting information to a mobile phone user. For the purpose of conducting speech communication, mobile phone 10 further preferably includes a microphone 13 and a speaker 14. Besides speaker 14, an additional speaker (not shown) may be employed inter alia for the purpose of providing alert signals to a mobile phone user, and as a loudspeaker. Otherwise, or in addition, speakers for presenting audio, such as music, to a user are typically provided in the form of a headset 22, which is communicatively connectable to the mobile phone. Mobile phone 10 may also include a digital camera 15. Typically, the camera 15 is placed on an opposite side of where display 12 is arranged, such that the display may be used as a viewer, which is why camera 15 is illustrated in phantom in FIG. 1. Additionally, another camera for video conferencing purposes (not shown) may be included on the same side as the display.

FIG. 2 illustrates the mobile phone 10 in the form of a block diagram. The actual function of mobile phone 10 as a radio communications device is not crucial to the invention, and will therefore not be described in detail. A radio signal transceiver 19 is included for transmission and reception of radio signals to and from a radio network or a radio terminal. As an example, the radio signal transceiver 19 may include an antenna and circuitry configured to transmit and receive communication signals over the mobile phone network 30. Other possible additional or alternative transceiver systems 19 may include an antenna and circuitry configured to receive radio signals over a direct WLAN Internet connection, or using a short range protocol such as bluetooth. The radio transceiver 19 is connected to a controller 18, which in a preferred embodiment represents a microprocessor system with associated memory space, operation software, and application software. Controller 18 is depicted in FIG. 2 as a central element, responsible for carrying out different tasks of the mobile phone, such as controlling communication sessions as well as controlling camera 15 and managing the user interface. A socket 16 is also illustrated as an example of how an audio headset 22 may be attached using a plug 21. Alternatively, the headset may be wirelessly connected using e.g. a bluetooth connection. A battery (not shown) or a connection to an exterior power source is typically also included. A media player 23 may also be included, such as an mp3 player. Media player 23 may be configured to play both recorded media stored in a media file memory (not shown) either in the device 10 or on an attachable memory carrier, and media received as e.g. a streaming media signal over a mobile phone network 30 or from a broadcast source.

During operation of the phone 10 or in standby mode, different events may take place in the phone. Examples of such events include detection of an incoming call or message; a game event such as a point scored or lost in a computer game played on the phone; an alarm set by a user or linked to a digital calendar; status change of a parameter in the phone, such as the battery charge level or memory occupancy, music or other audio played by the media player, and so on. For any one of these events, or other events, an alert signal is generated to draw the user's attention to the phone. For some alert signals, an audible signal is sufficient for obtaining the desired result. For instance, an incoming call signal will typically be immediately understood as being just that, and unless the user wants to check who is calling by looking at the display 12, the sound of the call signal is sufficient. Furthermore, some of the alert signals are typically used specifically for drawing the user's attention to the phone when the user may not be watching it, such as incoming call or message signals, and low battery signals, and are for that reason often audible. However, a silent mode may often be selected, in which all audible signals are suppressed in favor of only visual and/or tactile signals such as vibration. Needless to say, such visual and tactile signals may also be used in conjunction with audible signals.

The invention brings about a new type of visual alert signal, which may be used solely, or in combination with audible and/or tactile signals. The novel alert signal includes the feature of providing a distortion of graphics presented on the display 12 of the phone. In a preferred embodiment, the graphical distortion is configured to act as a filter on top of the presently shown graphics on the display 12. Preferably, two or more different types of distortion profiles are stored in a memory 20 in the phone, which are associated with different events. This way, even if both sound, vibration and illumination alerts are turned off, it may still be possible to understand which type of event has taken place in the phone. For example, there may be one distortion profile linked to incoming calls, another to incoming messages, yet another linked to alarms, and so on. The graphical distortion may be static or dynamic. In other words, an incoming call detected by controller 18 may trigger a digital signal processor in controller 18 to provide a graphical distortion to the presently shown graphics, which distortion is not moving but merely a spatial disposition of presented items. Alternatively, the distortion profile may indeed include a movement in the shown graphics, such as a wave form or a segmentation of the graphics.

In one embodiment, the distortion profile of a certain event is linked to an audible alert signal linked to the same event, in memory 20. As an example, a certain ring signal may be assigned in memory 20 either to a certain telephone number, or to all incoming calls. Using a signal analyzer in controller 18, the frequency content of the audible signal is analyzed. The analyzer may be configured to sort the audio content in two or more frequency bands, including a bass band and a treble band, and potentially one or more intermediate bands. Furthermore, the analyzer is configured to transfer the audio frequencies to spatial frequencies for use in the distortion profile. Different frequency bands may yield different types of distortion. Alternatively, different frequency bands may yield visual distortion of presented graphics with a spatial frequency dependent on the audio frequency of the associated and analyzed audio signal. As an example, a bass tone within a certain frequency band in the associated audio signal may result in a wave form in the presented graphics, having a predetermined spatial period appearing as large waves, whereas a treble tone within another and higher frequency band may result in a wave form in the presented graphics having a predetermined spatial period appearing as small waves or ripple in the presented image. By combining these two, or more, effects related to frequency bands of the associated audible signal and in synchronicity with the same, the distortion profile will appear as a visualization of the audio signal. As long as the audio signal is fairly simple, it will also be possible to recognize that audio signal from the distortion profile applied to the graphics. In an embodiment where the audible signal has an increasing magnitude, i.e. an increasing audio signal amplitude, also the amplitude of the graphical distortion is preferably increasing. In such an embodiment, the graphical distortion may initially be very weak, and then successively increase either continuously or stepwise to a maximum level of distortion amplitude.

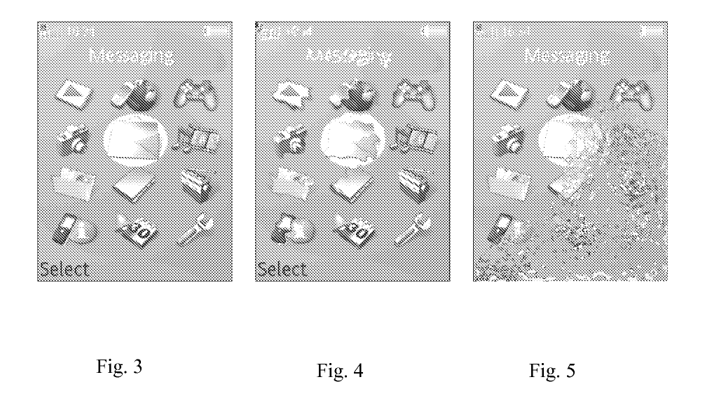

FIGS. 3-5 schematically illustrate an embodiment of the invention, applied to the graphics shown on a mobile phone. FIG. 3 illustrates desktop graphics including a number of icons, each representing menus for different services or functions according to the established art. A highlight is provided on the central icon, and the corresponding menu title “Messaging” is therefore presented at the top of the display. By operating a navigation key, the highlight may be moved.

FIG. 4 illustrates the same desktop graphics as in FIG. 3, but distorted using a bass distortion profile. The bass distortion profile generates a spatial disposition in the presented graphics in the form of a wave pattern. Again, the distortion may be static, i.e. that the graphics will actually appear as shown in FIG. 4. Preferably, though, the distortion is dynamic, and will appear as a moving wave pattern.

FIG. 5 illustrates the same desktop graphics as in FIGS. 3 and 4, but distorted using a treble distortion profile. Also the treble distortion profile may generate a spatial disposition in the presented graphics in the form of a wave pattern. However, in the shown embodiment the distortion is a segmentation or disintegration of the presented graphics. When the distortion has progressed to the point illustrated in FIG. 5, it may be difficult to determine the basic information or images of the graphics. However, the distortion need not be that severe. As in FIG. 4 it may instead be a mild distortion leaving the information or image still conceivable. As for the bass distortion, also the treble distortion may be static or dynamic.

For a non-static distortion, the distortion need not only be oscillating. As an alternative, the distortion may be a wave traveling over the display surface. It may also be devised such that the intensity, or amplitude, of the distortion in every segment of the display surface, increases and subsequently decreases in a wave form traveling over the display surface. In the drawings, this can be seen in both FIGS. 4 and 5. In FIG. 4 the distortion having a low spatial frequency is more intense towards the upper left corner of the display, whereas almost no effect can be seen in the lower right corner. In this embodiment, the intensity of the low frequency distortion travels diagonally across the display surface, such that the peak intensity goes from upper left to lower right, or vice versa, as a traveling wave. In FIG. 5 the corresponding peak intensity wave has traveled towards the lower right corner, such that the upper right corner is no longer affected by the distortion profile.

The embodiments depicted in FIGS. 4 and 5, and the alternative embodiments described in conjunction with those embodiments, are merely examples of how the invention may be carried out, and many other distortion profiles are conceivable. An advantage with at least a low intensity distortion is that the alert signal, while being clearly conceivable, still provides a clear overview of the information or image presently shown on the display. Furthermore, different distortion profiles may be defined, either automatically or manually, for different events and also for e.g. incoming messages or calls from different terminals. Therefore, unique alert signals for inter alia different events may be employed without actually spelling out the event on the display. This means that a high level of secrecy can be maintained, even if someone other that the dedicated user sees the display. For embodiments where the frequency content of an audio signal associated with a certain event is analyzed, and the distortion profile is configured to use a corresponding frequency spectrum in synchronicity with the audio signal, silent or not, a correlation is achieved between audio alert signals and graphics distortion alert signals, which increases the ability to recognize the distortion alert signal. Furthermore, since the distortion is applied as a filter on top of the displayed graphics and no consideration of the actual content of the graphics need to be taken, it is a solution of relatively low complexity with respect to the actual effect obtained.

As already noted, the invention as described by means of a number of different embodiments herein, may just as well be employed in other electronic devices that in mobile phones, provided the electronic device has a display and makes use of alert signals for the purpose of gaining a user's attention. Other types of electronic devices therefore include computers, media players, digital cameras and video recorders, electronic sensors, intelligent home equipment, tools, gauges and so on. The scope of the invention is only limited by the appended claims.

What is claimed is:

1. Method for providing an alert signal in an electronic device, comprising the steps of:
presenting graphics on a display of the device;
detecting an event in the device;
distorting the graphics on the display to alert a user of the device.

2. The method of claim 1, comprising the steps of:
determining type of the event;
distorting the graphics in accordance with a stored profile associated with the determined type of event.

3. The method of claim 1, comprising the steps of:
analyzing a sound signal associated with the event;
distorting the graphics dependent on the sound signal.

4. The method of claim 3, comprising the steps of:
analyzing audio frequency content of the sound signal associated with the event;
distorting the graphics dependent on the frequency content.

5. The method of claim 4, wherein the step of distorting the graphics comprises the step of:
providing an oscillation in the graphics having a spatial frequency correlating with the audio frequency of the sound signal.

6. The method of claim 3, comprising the steps of:
analyzing audio frequency content of the sound signal associated with the event, to determine presence of tones in a low frequency range and in a high frequency range;
distorting the graphics with a low spatial frequency for tones in the low frequency range, and with a high spatial frequency for tones in the high frequency range.

7. The method of claim 1, wherein the step of distorting the graphics comprises the step of:
providing an oscillation or segmentation of the presented graphics as a distortion filter applied over the presented graphics.

8. The method of claim 1, wherein the event is reception of an incoming telephone call or message.

9. The method of claim 1, wherein the event is computer game event of a game played on the electronic device.

10. The method of claim 1, wherein the event is a status change of a parameter in the electronic device.

11. The method of claim 1, wherein the event is an alarm.

12. The method of claim 1, wherein the electronic device is a mobile phone.
